(19) United States
(12) Patent Application Publication
(10) Pub. No.: US 2015/0029695 A1
(43) Pub. Date: Jan. 29, 2015

(54) BACKLIGHT MODULE AND LIQUID CRYSTAL DISPLAY

(71) Applicant: Kuojun Fang, Shenzhen (CN)

(72) Inventor: Kuojun Fang, Shenzhen (CN)

(73) Assignee: Shenzhen China Star Optoelectronics Technology Co. Ltd., Shenzhen (CN)

(21) Appl. No.: 13/511,696

(22) PCT Filed: Apr. 24, 2012
(86) PCT No.: PCT/CN12/74588

§ 371 Date: May 24, 2012

(30) Foreign Application Priority Data
Apr. 16, 2012 (CN) 201210110850.8

(51) Int. Cl. F21V 7/04; G02F 1/1335

(52) U.S. Cl. CPC F21V 7/04; G02F 1/133615
USPC 362/97.1

(57) ABSTRACT

A backlight module and a liquid crystal display are provided. The backlight module includes an optical film, a reflection plate, a light source and a curved reflection sheet. One end of the curved reflection sheet extends into a light guide region along a length direction of the optical film, and the other end of the curved reflection sheet and the optical film are respectively located at two opposite sides of the light source. A light-emitting surface of the light source faces the curved reflection sheet and the reflection plate. The lights emitted by the light source are all projected to the curved reflection sheet and the reflection plate, and then reflected by the curved reflection sheet and the reflection plate to enter into the optical film.

### BACKGROUND OF THE INVENTION

1. Field of the Invention

The present invention relates to a liquid crystal displaying technology field, and more particularly to a backlight module and a liquid crystal display.

2. Description of the Prior Art

With the continuous development of a liquid crystal display, the demand for the function of every component of the liquid crystal display becomes more and more high.

Please refer to FIG. 1, which is a structure schematic view of a backlight module in the prior art. The backlight module comprises a light source 11, an optical collimator 12 (such as a lens or a reflection cover), an optical film 13 and a reflection sheet 14.

Wherein, the optical collimator 12 adopts a paraboloidal reflector, the light source 11 is mounted within the optical collimator 12 and is enclosed by the optical collimator 12, and an exit of the optical collimator 12 is aligned with a light guide region formed between the optical film 13 and the reflection sheet 14. The optical collimator 12 approximately collimates the lights of the light source 11 to directly project into the light guide region between the optical film 13 and the reflection sheet 14. For the lights entering into the light guide region, one part thereof is directly incident to the optical film 13, and the other part thereof is reflected by the reflection sheet 14 to enter into the optical film 13.

Because the size of the optical collimator 12 is large and the length L′ thereof is generally over 15 millimeter, it takes up more space and limits the developing trend of the narrow frame of the backlight module.

### BRIEF SUMMARY OF THE INVENTION

One object of the present invention is to provide a backlight module to solve the technical problems of taking up more space and limiting the developing trend of the narrow frame of the backlight module because of the presence of the optical collimator and the length of optical collimator being longer in the prior art.

For solving above problems, the present invention provides a backlight module, comprising at least one light source, an optical film and a reflection plate being parallel to each other. There forms a light guide region between the optical film and the reflection plate. The length of the light guide region is equal to that of one having the longer length of the optical film and the reflection plate.

The backlight module also comprises a curved reflection sheet. One end of the curved reflection sheet extends into the light guide region along a length direction of the optical film and is connected to the reflection plate, and the other end of the curved reflection sheet and the optical film are respectively located at two opposite sides of the light source.

The light source is long bar-shaped. A center line along a length direction of the light source is located in a plane of the optical film. The light source includes a light-emitting surface. The light-emitting surface faces the curved reflection sheet and the reflection plate. All the lights emitted by the light source are projected to the curved reflection sheet and the reflection plate, and then reflected by the curved reflection sheet and the reflection plate to enter into the optical film.

In the backlight module of the present invention, the light-emitting surface of the light source is located on the plane of the optical film.

Wherein the length of the optical film is greater than that of the reflection plate, the one end of the curved reflection sheet extending into the light guide region is connected to one end of the reflection plate near the light source.

In the backlight module of the present invention, the curved reflection sheet is a half paraboloidal reflection cover, which has a center line defined by a top point and a focus thereof, the center line has a default angle relative to the light-emitting surface of the light source, and a range of the default angle is 0 degree to 20 degrees.

In the backlight module of the present invention, the center line of the curved reflection sheet rotates relative to the optical film to form the default angle.

In the backlight module of the present invention, the light source rotates relative to the optical film to form the default angle.

In the backlight module of the present invention, the light guide module comprises two light sources being oppositely symmetrical to the optical film.

If the default angle is formed by the clockwise rotation of the light source, a middle position of the reflection plate disposes a concave structure.

If the default angle is fanned by the anticlockwise rotation of the center line of the curved reflection sheet relative to the optical film, the middle position of the reflection plate disposes a convex structure.

In the backlight module of the present invention, the curved reflection sheet is constructed by multiple plane bending sections, and one plane bending section thereof near the light source is perpendicular to the optical film.

In the backlight module of the present invention, the curved reflection sheet is a smooth curved surface, the slope of which is gradually increased along the length direction of the optical film.

In the backlight module of the present invention, the curved reflection sheet and the reflection plate are integrally formed.

Another object of the present invention is to provide a backlight module to solve the technical problems of taking up more space and limiting the developing trend of the narrow frame of the backlight module because of the presence of the optical collimator and the length of optical collimator being longer in the prior art.

For solving above problems, the present invention provides a backlight module comprising at least one light source, an optical film and a reflection plate being parallel to each other. There forms a light guide region between the optical film and the reflection plate. The length of the light guide region is equal to that of one having the longer length of the optical film and the reflection plate.

The backlight module also comprises a curved reflection sheet. One end of the curved reflection sheet extends into the light guide region along a length direction of the optical film and is connected to the reflection plate, and the other end of the curved reflection sheet and the optical film are respectively located at two opposite sides of the light source.

The light source includes a light-emitting surface. The light-emitting surface faces the curved reflection sheet and the reflection plate. All the lights emitted by the light source are projected to the curved reflection sheet and the reflection plate, and then reflected by the curved reflection sheet and the reflection plate to enter into the optical film.

In the backlight module of the present invention, the light-emitting surface of the light source is located on the plane of the optical film.

Wherein the length of the optical film is greater than that of the reflection plate, the one end of the curved reflection sheet extending into the light guide region is connected to one end of the reflection plate near the light source.

In the backlight module of the present invention, the curved reflection sheet is a half paraboloidal reflection cover, which has a center line defined by a top point and a focus thereof, the center line has a default angle relative to the light-emitting surface of the light source, and a range of the default angle is 0 degree to 20 degrees.

In the backlight module of the present invention, the center line of the curved reflection sheet rotates relative to the optical film to form the default angle.

In the backlight module of the present invention, the light source rotates relative to the optical film to form the default angle.

In the backlight module of the present invention, the light guide module comprises two light sources being oppositely symmetrical to the optical film.

If the default angle is formed by the clockwise rotation of the light source, a middle position of the reflection plate disposes a concave structure.

If the default angle is formed by the anticlockwise rotation of the center line of the curved reflection sheet relative to the optical film, the middle position of the reflection plate disposes a convex structure.

In the backlight module of the present invention, the curved reflection sheet is constructed by multiple plane bending sections, and one plane bending section thereof near the light source is perpendicular to the optical film.

In the backlight module of the present invention, the curved reflection sheet is a smooth curved surface, the slope of which is gradually increased along the length direction of the optical film.

In the backlight module of the present invention, the curved reflection sheet and the reflection plate are integrally formed.

Another object of the present invention is to provide a liquid crystal display to solve the technical problems of taking up more space and limiting the developing trend of the narrow frame of the backlight module because of the presence of the optical collimator and the length of optical collimator being longer in the prior art.

For solving above problems, the present invention provides a liquid crystal display. The liquid crystal display comprises a backlight module. The backlight module comprises at least one light source, an optical film and a reflection plate being parallel to each other. There forms a light guide region between the optical film and the reflection plate. The length of the light guide region is equal to that of one having the longer length of the optical film and the reflection plate.

The backlight module also comprises a curved reflection sheet. One end of the curved reflection sheet extends into the light guide region along a length direction of the optical film and is connected to the reflection plate, and the other end of the curved reflection sheet and the optical film are respectively located at two opposite sides of the light source.

The light source includes a light-emitting surface. The light-emitting surface faces the curved reflection sheet and the reflection plate. All the lights emitted by the light source are projected to the curved reflection sheet and the reflection plate, and then reflected by the curved reflection sheet and the reflection plate to enter into the optical film.

Comparing with the prior art, the present invention employs the curved reflection sheet to replace the optical collimator of the prior art. One end of the curved reflection sheet may extend into the light guide region, and the other end thereof is disposed near the light source. The light-emitting surface of the light source faces the curved reflection sheet and the reflection plate. The lights emitted by the light source are all projected to the curved reflection sheet and the reflection plate. Obviously, because the curved reflection sheet may extend into the light guide region along the length direction of the optical film, the present invention can reduce the length of the backlight module and can assure the light guide effect.

For more clearly and easily understanding above content of the present invention, the following text will take a preferred embodiment of the present invention with reference to the accompanying drawings for detail description as follows.

### BRIEF DESCRIPTION OF THE DRAWINGS

FIG. 1 is a structure schematic view of a backlight module of the prior art;

FIG. 2 is a structure schematic view of a first preferred embodiment of a backlight module of the present invention;

FIG. 3 is a top plan schematic view of FIG. 2;

FIG. 4 is a schematic view of a full paraboloidal reflector corresponding to a curved reflection sheet of FIG. 2;

FIG. 5 is a structure schematic view of a second preferred embodiment of the backlight module of the present invention;

FIG. 6 is a schematic view of another structure of a reflection plate of FIG. 5;

FIG. 7 is a structure schematic view of a third preferred embodiment of the backlight module of the present invention; and

FIG. 8 is a structure schematic view of a fourth preferred embodiment of the backlight module of the present invention.

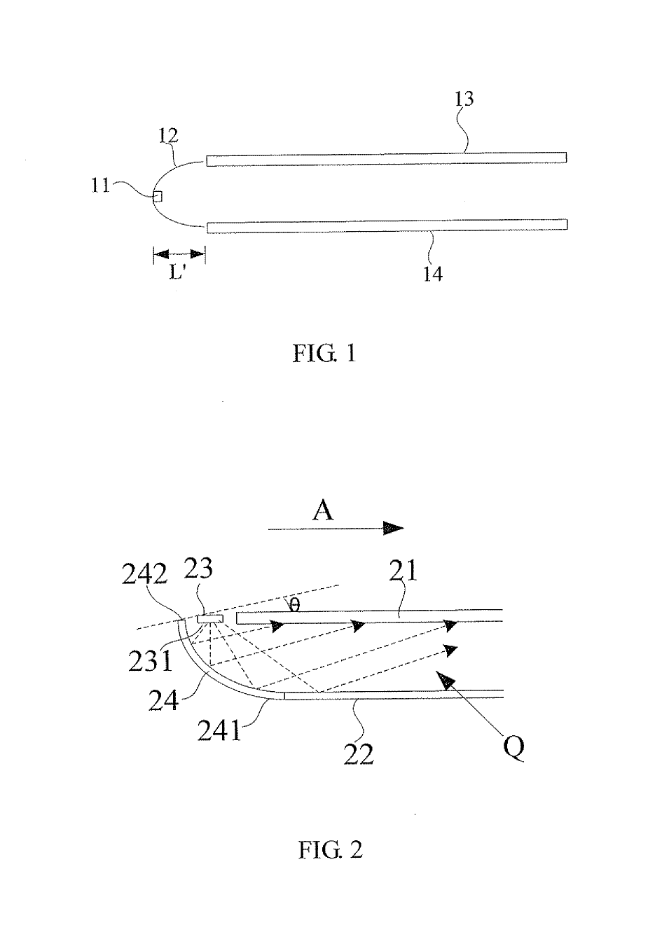

### DETAILED DESCRIPTION OF THE PREFERRED EMBODIMENTS

The following description of every embodiment with reference to the accompanying drawings is used to exemplify a specific embodiment, which may be carried out in the present invention.

FIG. 2 is a structure schematic view of a first preferred embodiment of a backlight module of the present invention.

The backlight module comprises an optical film. 21, a reflection plate 22, a light source 23 and a curved reflection sheet 24. The optical film 21 and the reflection plate 22 are parallel to each other. There forms a light guide region Q between the optical film 21 and the reflection plate 22. The light source 23 includes a light-emitting surface 231.

Wherein, along a length direction A of the optical film 21, the light guide region Q has a length (not shown in drawings). The length of the light guide region Q is determined by one having the longer length of the optical film 21 and the reflection plate 22. For example, if the length of the optical film 21 is greater than that of the reflection plate 22, the length of the light guide region Q is the length of the optical film 21.

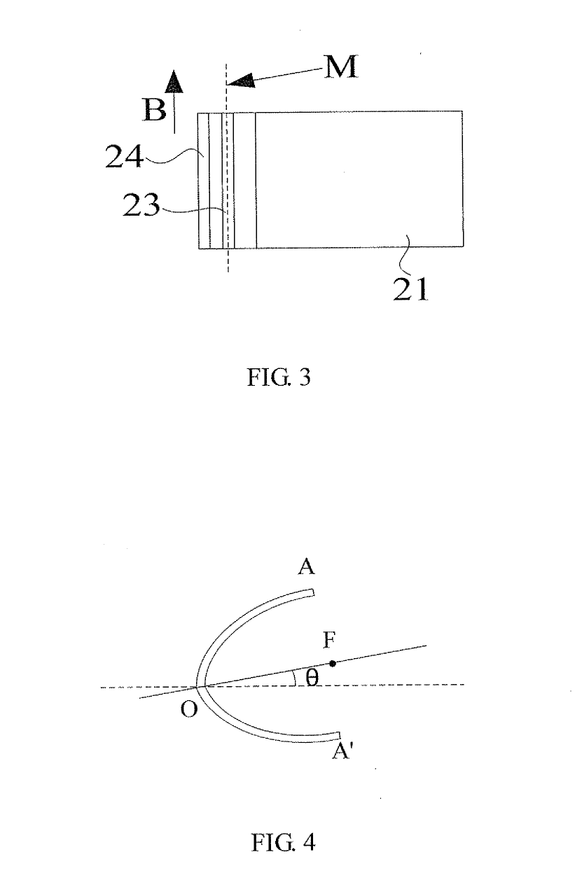

Please refer to FIG. 3, FIG. 3 is a top plan schematic view of FIG. 2. The light source 23 is long bar-shaped. In this embodiment, a center line M a length direction B of the light source 23 is located in a plane of the optical film 21.

Please refer to FIG. 2 again, one end 241 of the curved reflection sheet 24 extends into the light guide region Q, and the other end 242 thereof and the optical film 21 are respectively located at two opposite sides of the light source 23. Namely, the light source 23 is located between one side of the optical film 21 and the other end 242 of the curved refection sheet 24. The curved refection sheet 24 is used to reflect the lights coming from the light source 23 into the light guide region Q.

Specifically, in the embodiment shown by FIG. 2, the one end 241 of the curved reflection sheet 24 extends into the light guide region Q and is connected to the reflection plate 22. Certainly, in the specific implementation process, the connection between the curved reflection sheet 24 and the reflection plate 22 may be jointed or adhered or overlapped together, and also may be an integral structure directly formed by an integral forming method, it only needs to prevent the light leakage between the both for assuring the lights from the light source 23 all to be reflected into the light guide region Q, so no more repeated herein.

In this embodiment, the light-emitting surface 231 of the light source 23 faces the curved reflection sheet 24 and the reflection plate 22. The present invention may control the orientation of the light-emitting surface 231 so that the lights emitted from the light-emitting surface 231 are all projected to the curved reflection sheet 24 and the reflection plate 22, and are reflected by the curved reflection sheet 24 and the reflection plate 22 to enter into the optical film 21.

In the first preferred embodiment of FIG. 2, the curved reflection sheet 24 is preferably a half paraboloidal reflection cover. As shown in FIG. 4, the half paraboloidal reflection cover has a center line OF defined by a top point 0 and a focus F thereof. Furthermore, the half paraboloidal reflection cover is corresponding to a whole paraboloidal reflection cover AOA′ (please refer to FIG. 4). The symmetrical axis of the whole paraboloidal reflection cover AOA′ is the center line OF. The center line OF has a default angle θ relative to the light-emitting surface 231 of the light source 23. The range of the default angle θ is 0 degree to 20 degrees.

In the specific implementation process, above default angle θ is obtained by the following two ways:

first, controlling the light-emitting surface 231 of the light source 23 and the optical film 21 to be coplanar, and controlling the center line OF of the curved reflection sheet 24 to anticlockwise rotate the angle θ relative to the optical film 21, please refer to FIG. 4;

second, maintaining the center line OF of the curved reflection sheet 24 to be invariable along the direction A shown by FIG. 2, and controlling the light-emitting surface 231 of the light source 23 to clockwise rotate the angle θ relative to the optical film 21.

The present invention can control the default angle θ of the curved reflection sheet 24 relative to the light-emitting surface 231 of the light source 23, so the lights emitted by the light source 23 are all projected to the curved reflection sheet 24 and the reflection plate 22, and the curved reflection sheet 24 and the reflection plate 22 can reflect the lights coining from the light source 23 into the light guide region Q, thereby realizing a preferred light-coupling effect.

Wherein, the first preferred embodiment of FIG. 2 adopts a single side-light mode. The working principle of the backlight module of the single side-light mode shown by FIGS. 2 to 4 is as follows.

When the backlight module works, because the light-emitting surface 231 of the light source 23 faces the curved reflection sheet 24 and the reflection plate 22, the lights emitted from the light source 23 are projected to the curved reflection sheet 24 and the reflection plate 22, and are reflected by the curved reflection sheet 24 and the reflection plate 22 to enter into the optical film 21.

The center line M of the light-emitting surface 231 of the light source 23 along the length direction B thereof shown in FIG. 3 is coplanar with the optical film 21, and may be moved along the direction A shown by FIG. 2 to adjust a fitted light-emitting position thereof.

One end 241 of the curved reflection sheet 24 extends into the light guide region Q, and the other end 242 is located one side of the light source 23. Accordingly, the light source 23 and the curved reflection sheet 24 may be freely moved along the direction A shown in FIG. 2. Obviously, the curved reflection sheet 24 and the light source 23 in the present invention may extend into the light guide region Q along the direction A of FIG. 2 according to the demand, thereby reducing the length of the backlight module in the direction A.

Moreover, after the lights emitted from the light source 23 are reflected by the curved reflection sheet 24 and the reflection plate 22, the lights all can enter into the optical film 21, thereby better assuring the light guide effect of the backlight module.

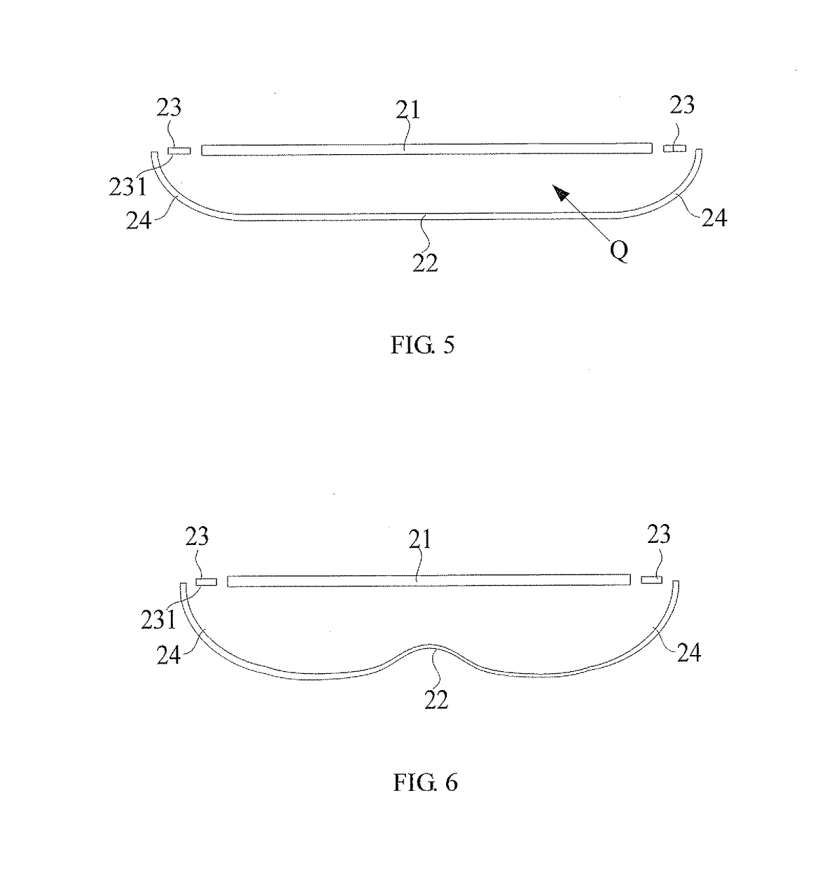

FIG. 5 is a structure schematic view of a second preferred embodiment of the backlight module of the present invention.

The difference with the first preferred embodiment shown in FIG. 2 is in that: the second preferred embodiment shown in FIG. 5 is double side-light mode.

In detail, the backlight module comprises the optical film 21, the reflection plate 22, two curved reflection sheets 24 respectively located two ends of the reflection plate 22, and two light sources 23 respectively located at two sides of the optical film 21. The optical film 21 and the reflection plate 22 are parallel to each other. There forms the light guide region Q between the optical film 21 and the reflection plate 22. The two light sources 23 both include the light-emitting surface 231. The light-emitting surface 231 faces to the curved reflection sheet 24 and the reflection plate 22.

As shown in FIG. 5, one end of each curved reflection sheet 24 extends into the light guide region Q and is connected to corresponding one end of the reflection plate 22, and the other end of each curved reflection sheet 24 is located at one side of the light source 23 corresponding thereto, so that the lights emitted by the light-emitting surface 231 of each light source 23 are all projected into the curved reflection sheet 24 and the reflection plate 22 corresponding to the light source 23, and are reflected by the curved reflection sheet 24 and the reflection plate 22 to enter into the optical film 21.

In the second embodiment shown by FIG. 5, the reflection plate 22 is a planar structure, but the reflection plate 22 also may be designed to a free curved surface, as shown by FIG. 6, according to the special optical demand.

Please refer to FIG. 6, the curved reflection sheet 24 adopts the way shown by FIG. 4 to make the center line OF rotate the angle θ relative to the optical film 21. Now, the middle position of the reflection plate 22 is designed to a gradient-type convex structure for satisfying a special optical demand.

Certainly, if the light-emitting surface 231 of each light source 23 clockwise rotates the angle θ relative to the optical film 21, the middle position of the reflection plate 22 forms a concave structure. Of course, the concave structure is a gradient-type concave, so no more given a drawing herein.

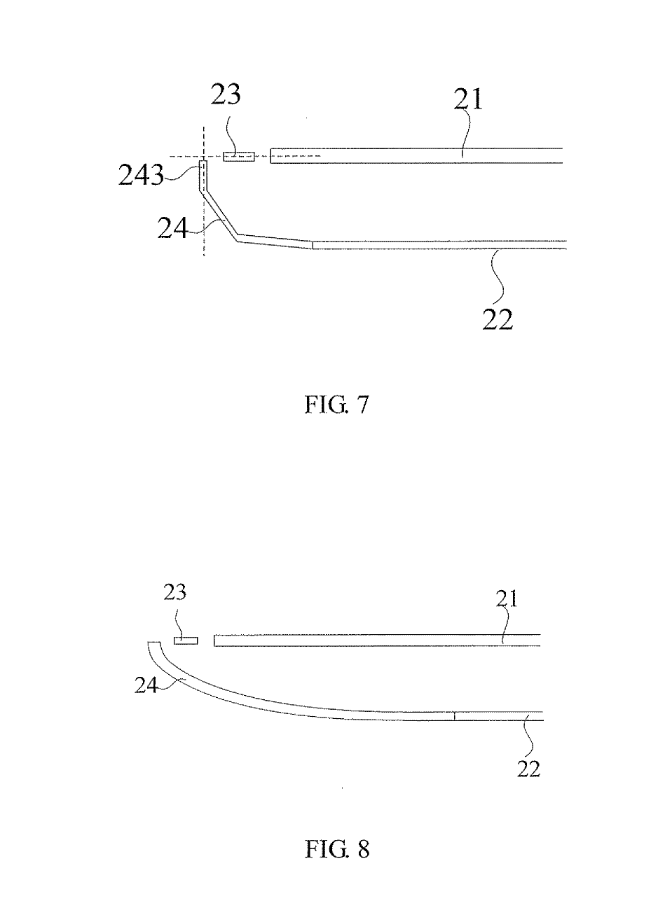

FIG. 7 is a structure schematic view of a third preferred embodiment of the backlight module of the present invention.

The difference with the first preferred embodiment shown in FIG. 2 is in that: in the third preferred embodiment shown in FIG. 7, the curved reflection sheet 24 is constructed by multiple plane bending sections, and one plane bending section thereof near the light source 23 is perpendicular to the optical film 21. The function is to prevent the occurrence of bright lines on one end of the curved reflection sheet 24 near the light-emitting surface of the light source 23, and further to enhance the light-coupling effect.

Of course, the curved reflection sheet 24 also may be used in the double side-light mode, so no more repeated herein.

FIG. 8 is a structure schematic view of a fourth preferred embodiment of the backlight module of the present invention.

The difference with the first preferred embodiment shown in FIG. 2 is in that: in the fourth preferred embodiment shown in FIG. 8, the curved reflection sheet 24 is a smooth curved surface, the slope of which is gradually increased along the direction A shown by FIG. 2.

The working principle of the backlight module of the second to fourth preferred embodiments can refer to the above description of the working principle of the backlight module of the first preferred embodiment of FIG. 2, so no more mentioned herein.

The present invention also provides a liquid crystal display, which comprises the backlight module provided by the present invention. Because the backlight module has been described in detail in the above text, no more repeated it herein.

In a word, the present invention employs the curved reflection sheet to replace the paraboloidal reflector of the prior art. One end of the curved reflection sheet may extend into the light guide region, and the other end thereof is disposed at one side of the light source. The light-emitting surface of the light source faces the curved reflection sheet and the reflection plate. The lights emitted by the light source are all projected to the curved reflection sheet and the reflection plate. Obviously, because the curved reflection sheet may extend into the light guide region along the length direction of the optical film, the present invention can reduce the length of the backlight module and can assure the light guide effect.

In conclusion, although the present invention has been disclosed by above preferred embodiments, above preferred embodiments are not used to limit the present invention. One of ordinary skills in the art also can make all sorts of improvements and amendments within the principles of the present invention. Therefore, the protection scope of the present invention should be based on the scope defined by the appended claims.

What is claimed is:

1. A backlight module, comprising at least one light source, an optical film and a reflection plate being parallel to each other, there forming a light guide region between the optical film and the reflection plate, the length of the light guide region being equal to that of one having the longer length of the optical film and the reflection plate, wherein:
the backlight, module also comprising a curved reflection sheet, one end of the curved reflection sheet extending into the light guide region along a length direction of the optical film and being connected to the reflection plate, and the other end of the curved reflection sheet and the optical film being respectively located at two opposite sides of the light source;
the light source being long bar-shaped, a center line along a length direction of the light source being located in a plane of the optical film; the light source including a light-emitting surface, the light-emitting surface facing the curved reflection sheet and the reflection plate, all the lights emitted by the light source being projected to the curved reflection sheet and the reflection plate and being reflected by the curved reflection sheet and the reflection plate to enter into the optical film.

2. The backlight module as claimed in claim 1, wherein the light-emitting surface of the light source is located on the plane of the optical film;
wherein the length of the optical film is greater than that of the reflection plate, the one end of the curved reflection sheet extending into the light guide region is connected to one end of the reflection plate near the light source.

3. The backlight module as claimed in claim 1, wherein the curved reflection sheet is a half paraboloidal reflection cover, which has a center line defined by a top point and a focus thereof, the center line has a default angle relative to the light-emitting surface of the light source, and a range of the default angle is 0 degree to 20 degrees.

4. The backlight module as claimed in claim 3, wherein the center line of the curved reflection sheet rotates relative to the optical film to form the default angle.

5. The backlight module as claimed in claim 3, wherein the light source rotates relative to the optical film to form the default angle.

6. The backlight module as claimed in claim 3, wherein the light guide module comprises two light sources being oppositely symmetrical to the optical film;
if the default angle is formed by the clockwise rotation of the light source, a middle position of the reflection plate disposes a concave structure;
if the default angle is formed by the anticlockwise rotation of the center line of the curved reflection sheet relative to the optical film, the middle position of the reflection plate disposes a convex structure.

7. The backlight module as claimed in claim 1, wherein the curved reflection sheet is constructed by multiple plane bending sections, and one plane bending section thereof near the light source is perpendicular to the optical film.

8. The backlight module as claimed in claim 1, wherein the curved reflection sheet is a smooth curved surface, the slope of which is gradually increased along the length direction of the optical film.

9. The backlight module as claimed in claim 2, wherein the curved reflection sheet and the reflection plate are integrally formed.

10. A backlight module, comprising at least one light source, an optical film and a reflection plate being parallel to each other, there fanning a light guide region between the optical film and the reflection plate, the length of the light guide region being equal to that of one having the longer length of the optical film and the reflection plate, wherein:
the backlight module also comprising a curved reflection sheet, one end of the curved reflection sheet extending into the light guide region along a length direction of the optical film and being connected to the reflection plate, and the other end of the curved reflection sheet and the optical film being respectively located at two opposite sides of the light source;
the light source including a light-emitting surface, the light-emitting surface facing the curved reflection sheet and the reflection plate, all the lights emitted by the light source being projected to the curved reflection sheet and the reflection plate, and then being reflected by the curved reflection sheet and the reflection plate to enter into the optical film.

11. The backlight module as claimed in claim 10, wherein the light-emitting surface of the light source is located on the plane of the optical film;
wherein the length of the optical film is greater than that of the reflection plate, the one end of the curved reflection sheet extending into the light guide region is connected to one end of the reflection plate near the light source.

12. The backlight module as claimed in claim 10, wherein the curved reflection sheet is a half paraboloidal reflection cover, which has a center line defined by a top point and a focus thereof, the center line has a default angle relative to the light-emitting surface of the light source, and a range of the default angle is 0 degree to 20 degrees.

13. The backlight module as claimed in claim 12, wherein the center line of the curved reflection sheet rotates relative to the optical film to form the default angle.

14. The backlight module as claimed in claim 12, wherein the light source rotates relative to the optical film to form the default angle.

15. The backlight module as claimed in claim 12, wherein the light guide module comprises two light sources being oppositely symmetrical to the optical film;
if the default angle is formed by the clockwise rotation of the light source, a middle position of the reflection plate disposes a concave structure;
if the default angle is formed by the anticlockwise rotation of the center line of the curved reflection sheet relative to the optical film, the middle position of the reflection plate disposes a convex structure.

16. The backlight module as claimed in claim 10, wherein the curved reflection sheet is constructed by multiple plane bending sections, and one plane bending section thereof near the light source is perpendicular to the optical film.

17. The backlight module as claimed in claim 10, wherein the curved reflection sheet is a smooth curved surface, the slope of which is gradually increased along the length direction of the optical film.

18. The backlight module as claimed in claim 11, wherein the curved reflection sheet and the reflection plate are integrally formed.

19. A liquid crystal display, wherein, the liquid crystal display comprising a backlight module, the backlight module comprising at least one light source, an optical film and a reflection plate being parallel to each other, there forming a light guide region between the optical film and the reflection plate, the length of the light guide region being equal to that of one having the longer length of the optical film and the reflection plate;
the backlight module also comprising a curved reflection sheet, one end of the curved reflection sheet extending into the light guide region along a length direction of the optical film and being connected to the reflection plate, and the other end of the curved reflection sheet and the optical film being respectively located at two opposite sides of the light source;
the light source including a light-emitting surface, the light-emitting surface facing the curved reflection sheet and the reflection plate, all the lights emitted by the light source being projected to the curved reflection sheet and the reflection plate, and then being reflected by the curved reflection sheet and the reflection plate to enter into the optical film.
